(19) United States
(12) Patent Application Publication
(10) Pub. No.: US 2021/0213717 A1
(43) Pub. Date: Jul. 15, 2021

(54) LASER MARKABLE MATERIALS COMPRISING A POLYAMIDE COMPONENT AND CARBON BLACK

(71) Applicants: Evonik Operations GmbH, Essen (DE); Evonik Specialty Chemicals (Shanghai) Co., Ltd., Shanghai (CN)

(72) Inventors: Huifeng YU, Shanghai (CN); Jianmin Yang, Shanghai (CN); Fei Teng, Shanghai (CN); Florian Hermes, Haltern am See (DE); Rainer Göring, Borken (DE); Chenyu Ye, Shanghai (CN)

(73) Assignees: Evonik Operations GmbH, Essen (DE); Evonik Specialty Chemicals (Shanghai) Co., Ltd., Shanghai (CN)

(21) Appl. No.: 17/250,084

(22) PCT Filed: May 25, 2018
(86) PCT No.: PCT/CN2018/088510

§ 371 Date: Nov. 23, 2020

(51) Int. Cl. B32B 27/18; C08K 3/04; C08J 7/12; B42D 25/36; B42D 25/41; B32B 27/34; B32B 27/08

(52) U.S. Cl. CPC B32B 27/18; C08K 3/04; C08J 7/123; B42D 25/36; B42D 25/41; B42D 25/23; B32B 27/08; C08K 2201/005; C08K 2201/011; C08J 2377/06; B32B 27/34

(57) ABSTRACT

A laser markable polymer composite contains (a) a polyamide component as the matrix and (b) carbon black as a laser-sensitive additive. The polyamide component has, based on the total weight thereof, at least 50 wt % a poly amide selected from a linear aliphatic polyamide (a1) or (a2), a cycloaliphatic polyamide (a3), a semi-aromatic polyamide (a4) or (a5), and the compound or copolymer thereof. The carbon black is present in an amount of 50-300 ppm, based on the total weight of the polymer composite. The composite results in better chemical resistance than conventional polycarbonate as the matrix, in addition to a desired quality of laser marking, specifically sharpness and resolution. This composite can also be used for a moulded article made of the laser markable polymer composite, a layered structure with at least one layer made of the laser markable polymer composite, and a security and/or valuable document with the layered structure.

### FIELD OF THE INVENTION

The present invention relates to laser markable materials, particularly to a polymer composite comprising a polyamide component and carbon black.

### BACKGROUND

Inscribing plastics by means of laser engraving is widely used in security documents, in particular identification documents such as passports, passes, ID cards or credit cards. The black-and-white personalisation of cards by means of laser engraving, that is to say the application of lettering or images such as black-and-white photographs, is generally known. Personalisation by means of laser engraving is generally distinguished in particular by its high security against forgery. The (text) image is formed on the inside of the card, so that it is not possible to remove the (text) image and produce a new (text) image.

At present, the most commonly used plastics in laser engraving identification cards and security documents are polycarbonates. For example, US2012001413 describes a layered structure having laser engravability wherein the layer for laser engraving is polycarbonate based.

However, there are a number of disadvantages with the cards made of polycarbonates, for example, their relatively poor resistance towards some industrial chemicals (such as organic solvents) and some daily used chemicals (such as creams and lotions), which leads to cracking and ultimately results in potential damages and reduced lifetime of the cards upon the exposure to these chemicals.

There is therefore a need for a laser markable material with better chemical resistance.

### SUMMARY OF THE INVENTION

The present invention provides a laser markable polymer composite, comprising:

(a) a polyamide component as the matrix, and
(b) carbon black as a laser-sensitive additive,
wherein
the polyamide component consists of based on the total weight thereof at least 50 wt % a polyamide selected from the group consisting of:
(a1) a linear aliphatic polyamide of the AB type having 10-12 carbon atoms, produced by polymerizing lactams having from 10-12 carbon atoms in the monomer unit or by polycondensing a ω-aminocarboxylic acids having from 10-12 carbon atoms in the monomer unit, or
(a2) a linear aliphatic polyamide of the AABB type, produced by polycondensing diamines having 6-14 carbon atoms in the monomer units and dicarboxylic acids having 9-14 carbon atoms in the monomer unit, or
(a3) a cycloaliphatic polyamide, produced by polycondensing a cycloaliphatic diamine having 10-20 carbon atoms in the monomer units and an aliphatic dicarboxylic acid having 8-18 carbon atoms in the monomer units, optionally further produced by a lactam having 6-14 carbon atoms or a linear aliphatic ω-aminocarboxylic acid having 6-14 carbon atoms, or
(a4) a semi-aromatic polyamide based on an cycloaliphatic diamine having 10-20 carbon atoms and an aromatic dicarboxylic acid having 8-18 carbon atoms, optionally further produced by a lactam having 6-14 carbon atoms or a linear aliphatic ω-aminocarboxylic acid having 6-14 carbon atoms,
(a5) a semi-aromatic polyamide based on an aliphatic diamine having 2-12 carbon atoms and an aromatic dicarboxylic acid having 8-18 carbon atoms, optionally further produced by a lactam having 6-14 carbon atoms or a linear aliphatic ω-aminocarboxylic acid having 6-14 carbon atoms,
and the compound thereof as well as the copolymer thereof,
the carbon black is present in an amount of 50-300 ppm, based on the total weight of the polymer composite.

Within the scope of the invention, ppm means ppm by weight, unless indicated otherwise.

A copolymer in view of this invention is a product of a copolymerization of at least two of the above-described polyamides (a1), (a2), (a3), (a4), (a5).

The present invention also provides the use of, and the moulded article made of the laser markable polymer composite.

The present invention further provides a layered structure comprising at least one layer made of the laser markable polymer composite and its production as well as a security and/or valuable document comprising the layered structure.

The present invention is based on the following findings:

(1) the selection of the polyamide and the amount of the carbon black result in both sufficient transparency and sufficient absorption centres for the laser energy, such that desired quality (that is to say sharpness and resolution) of laser marking is achieved, and
(2) the selection of the polyamide as the matrix results in better chemical resistance than conventional polycarbonates as the matrix.

### DETAILED DESCRIPTION OF THE INVENTION

The laser markable polymer composite of the present invention comprises a polyamide component as matrix which consists of based on the total weight thereof at least 50 wt % a polyamide selected from the above polyamides (a1), (a2), (a3), (a4), (a5) and the compound thereof as well as the copolymer thereof.

Polyamides (a1) to (a5) are suitable polyamide components. Preferred polyamides are (a1), (a2), or (a3), more preferably (a1) or (a3) and especially (a3).

Preferably, the polyamide component consists of based on the total weight thereof at least 70 wt %, more preferably at least 90 wt %, and particularly preferably at least 95 wt % a polyamide selected from the above polyamides (a1), (a2), (a3), (a4), (a5) and the compound thereof as well as the copolymer thereof.

The linear aliphatic polyamide (a1) has from 10-12 carbon atoms in the individual monomer units. Said linear aliphatic polyamide is producible from a combination of a diamine and a dicarboxylic acid, from an w-aminocarboxylic acid and/or the corresponding lactam. The monomer units in question are therefore the units which derive from the lactam, ω-aminocarboxylic acid, diamine or dicarboxylic acid. Suitable linear aliphatic polyamides (a1) further include copolyamides which comprise diamines having 6-14 carbon atoms in the monomer unit and dicarboxylic acids having 9-14 carbon atoms in the monomer unit (e.g. PA12/1012).

The following polyamides (a1), (a2) are suitable by way of example: PA88, PA79, PA97, PA610, PA106, PA99, PA810, PA108, PA612, PA126, PA10, PA1010, PA812, PA128, PA614, PA146, PA11, PA1012, PA1210, PA913, PA139, PA814, PA148, PA616, PA12, PA1212, PA1113, PA1014, PA1410, PA816, PA618 and compounds as well as copolyamides based on these systems.

Commercially available products of the linear aliphatic polyamide (a1) or (a2) are for example PA12 products under the tradename of VESTAMID® L, commercially available from Evonik Resource Efficiency GmbH, such as VESTAMID® L2101F and VESTAMID® L1940.

Suitable cycloaliphatic diamines of the cycloaliphatic polyamide (a3) and the semi-aromatic polyamide (a4) are for example bis-(4-amino-3-methyl-cyclohexyl)-methane (MACM), bis-(4-amino-cyclohexyl)-methane (PACM), bis-(4-amino-3-ethyl-cyclohexyl)-methane (EACM), bis-(4-amino-3,5-dimethyl-cyclohexyl)-methane (TMDC), 2,2-(4,4′-diaminodicyclohexyl)propane (PACP), and the mixtures thereof.

Suitable aliphatic dicarboxylic acids of the cycloaliphatic polyamide (a3) are for example sebacic acid, undecanedioic acid, dodecanedioic acid, tridecanedioic acid (brassylic acid), tetradecanedioic acid, pentadecanedioic acid, hexadecanedioic acid, and the mixtures thereof.

Suitable aromatic dicarboxylic acids of the semi-aromatic polyamides (a4) or (a5) are for example isophthalic acid, terephthalic acid, and naphthalene dicarboxylic acid, and the mixtures thereof.

The cycloaliphatic polyamide (a3) is typically produced from the cycloaliphatic diamine and the dicarboxylic acid. However, derivatives thereof may also be employed, for example the diisocyanate which derives from the cycloaliphatic diamine, or a dicarboxylic diester which derives from the dicarboxylic acid.

Preferably, the cycloaliphatic polyamide (a3) is selected from the group consisting of MACM10, MACM11, MACM12, MACM13, MACM14, MACM16, PACM10, PACM11, PACM12, PACM13, PACM14, PACM16, TMDC10, TMDC11, TMDC12, TMDC13, TMDC14, TMDC15, TMDC16, and compounds as well as copolyamides based on these systems.

Preferably, the semi-aromatic polyamide (a4) is selected from the group consisting of MACMI/12, MACMT/12, PACMI/12, PACMT/12, and compounds as well as copolyamides based on these systems.

The cycloaliphatic diamine may exist as a mixture of isomers. For example, PACM may exist as a mixture of cis, cis, cis, trans and trans, trans isomers. It is commercially available with various isomer ratios. In one preferred embodiment the trans, trans isomer content of the PACM or of the employed derivative thereof is 30-70% and particularly preferably from 35-65%.

More preferably, the cycloaliphatic polyamide (a3) or the semi-aromatic polyamide (a4) is transparent with a haze of less than 3% and particularly preferably of less than 2% where both properties are determined to ASTM D1003 on injection moulded test specimens of 2 mm in thickness.

Commercially available products of the cycloaliphatic polyamide (a3) are for example PA PACM12 products under the tradename of TROGAMID®, commercially available from Evonik Resource Efficiency GmbH, such as TROGAMID® CX7323 and TROGAMID® CX9704.

The semi-aromatic polyamide (a5) is based on an aliphatic diamine having 2-12 carbon atoms and an aromatic dicarboxylic acid having 8-18 carbon atoms.

Suitable aliphatic diamines are for example ethylenediamine, butanediamine, pentanediamine, hexamethylenediamine, octanediamine, methyloctanediamine, nonanediamine, decanediamine, undecanediamine, dodecanediamine, trimethylhexamethylenediamine, methyl pentanediamine, and the mixtures thereof.

Suitable aromatic dicarboxylic acids are for example isophthalic acid, terephthalic acid, and naphthalene dicarboxylic acid, and the mixtures thereof.

Preferably, the semi-aromatic polyamide (a5) is selected from the group consisting of PA6I/6T, PA 10T/6T, PA6T/6I and PA6-3-T and compounds as well as copolyamides based on these systems.

Commercially available products of the semi-aromatic polyamide (a5) are for example PA6-3-T products under the tradename of TROGAMID® and PA6I/6T products under the tradename of VESTAMID® HTplus, both commercially available from Evonik Resource Efficiency GmbH, such as TROGAMID® T5000 and VESTAMID® HTplus M5000.

The laser markable polymer composite of the present invention comprises carbon black as a laser-sensitive additive.

Preferably, the carbon black has a particle size of 10 nm-10 μm, and more preferably of 50 nm-2 μm.

Preferably, the carbon black is present in the polymer composite in an amount of 100-250 ppm, more preferably 120-200 ppm, and most preferably 120-180 ppm.

Commercially available products of the carbon black are for example carbon black products under the tradenames Printex® and Lamp black both commercially available from Orion Engineered Carbons GmbH, such as Lamp black 101.

The laser markable polymer composite of the present invention may include other ingredients, such as stabilizers, lubricants, colorants, plasticizers, nucleants, antioxidants, impact modifiers and UV absorbers, depending on the desired performance without impairing the transparency significantly. Preferably, these ingredients are added in low amounts, typically up to 20 wt %, more preferably up to 5 wt % of the total composite.

The laser markable polymer composite of the present invention can be produced for example in a twin-screw compounding extruder at conventional processing temperatures for the polyamides.

The present invention also provides use of the laser markable polymer composite as material for producing mouldings which are marked with the aid of lasers.

The present invention further provides the moulded article made of the laser markable polymer composite. Preferably, the moulded article is in the form of a film.

The layered structure of the present invention comprises:

(A) at least one layer (A) comprising a thermoplastic plastic, and
(B) at least one layer (B) made of the laser markable polymer composite.

There is no limit to the thermoplastic plastic of layer (A), examples of which include cellulose acetate propionate, cellulose acetate butyrate, polyesters, polyamides, polycarbonates, polyimides, polyolefins, polyvinylchlorides, polyvinylacetals, polyethers and polysulphonamides. Preferably, the thermoplastic plastic of layer (A) is a polyamide identical to the polyamide component of layer (B) for compatibility reason.

Layer (A) can additionally comprise a white pigment, which improves the visibility of the incorporated inscription or image(s) formed in layer (B). Preferably, the white pigment is selected from titanium dioxide, zirconium dioxide, barium sulfate, zinc oxide and zinc sulfide.

Commercially available products of the white pigment are for example titanium dioxide products under the tradename of Ti-Pure™, commercially available from the Chemours Company, such as Ti-Pure™ R-105.

Preferably, the layered structure comprise at least three layers wherein layer (A) is between two layers (B).

Such an at least three-layered structure has the advantage that, when it is incorporated into a security document, it is not necessary to ensure that the layer (B) (which is laser markable) is oriented outwards.

The layered structure of the present invention can have one or more further layer(s) comprising at least one thermoplastic plastic between the layer (A) and the layer(s) (B). These can be translucent or white layers, transparent layers or coloured layers.

The layered structure of the present invention, is outstandingly suitable as a component of security documents, preferably identification documents, which are to be inscribed by means of laser engraving.

The layered structure of the present invention can be produced, for example and preferably, by means of lamination, coextrusion, in mould labeling, and direct gluing of the layers that are present.

The layered structure according to the invention is particularly preferably suitable for identification and/or valuable documents in the form of bonded or laminated layers in the form of plastics cards.

Accordingly, the invention further provides an identification and/or valuable document, comprising at least the layered structure of the present invention. The identification and/or valuable documents are for example identification cards, passports, driving licenses, credit cards, bank cards, cards for controlling access or other identity documents, etc.

The identification and/or valuable document can further comprise additional layers which provide protection against UV radiation, protection against mechanical and chemical damage etc.

But due to the better chemical resistance achieved by the polymer composite of the present invention in the layer(s) (B), compared with polycarbonates which are commonly used at present, an additional layer for the protection against damages caused by industrial and daily chemicals, e.g. organic solvents, creams and lotions, might be saved.

### DRAWINGS

FIGS. 1-18 are the scanned images of the laser engraved samples of E1b-E17b and CE1b respectively,

FIGS. 19-23 are the scanned images of the laser engraved samples of E2b, E6b, E8b, E10b and CE1b respectively after the treatment with acetone,

FIGS. 24-28 are the scanned images of the laser engraved samples of E2b, E6b, E8b, E10b and CE1b respectively after the treatment with Banana Boat® Sport Sunscreen Lotion—SPF 30.

### EXAMPLES

Material

TROGAMID® CX7323: PA PACM12, a polyamide produced from bis(4-aminocyclohexyl)methane and also dodecanedioic acid; ηᵣₑₗ=1.8; commercially available from Evonik Resource Efficiency GmbH;

VESTAMID® L2101F: a base-unit PA12 with ηᵣₑₗ=2.2, commercially available from Evonik Resource Efficiency GmbH;

TROGAMID® T5000: a polyamide consisting of tere-phthalic acid and 2,2,4-/2,4,4-trimethyl hexamethylene diamine, commercially available from Evonik Resource Efficiency GmbH;

VESTAMID® HTplus M5000: a PA6I/6T copolymer, commercially available from Evonik Resource Efficiency GmbH;

VESTAMID® DS22: a base-unit PA1010 with ηᵣₑₗ=2.2, commercially available from Evonik Resource Efficiency GmbH;

VESTAMID® HS22: a base-unit PA610 with ηᵣₑₗ=2.2, commercially available from Evonik Resource Efficiency GmbH;

Panlite® L-1250Y: Polycarbonate (PC), commercially available from Teijin Limited;

Ti-Pure™ R-105: Titanium dioxide, commercially available from the Chemours Company;

Ultranox® 626: Phosphite commercially available from Addivant Germany GmbH; Lamp black 101: Carbon black with an average particle of 95 nm, commercially available from Orion Engineered Carbons GmbH.

Preparation of Masterbatches

Masterbatch granules having the compositions and the weight percentages as indicated in the following table 1 were prepared in a twin-screw compounding extruder (Coperion ZSK-26mc) at conventional processing temperatures for the materials as following:

### TROGAMID® CX7323: 260-300° C.;

### VESTAMID® L2101F: 250-300° C.;

### TROGAMID® T5000: 260-300° C.;

### VESTAMID® HTplus M5000: 280-310° C.;

### VESTAMID® DS22: 250-300° C.;

### VESTAMID® HS22: 250-300° C.;

### Panlite® L-1250Y of 260-300° C.

Preparation of the Polymer Composites and the Films Made Thereof

Polymer composites and the films of the examples (E1a-E17a) and the comparative example (CE1a) were prepared as following:

The installation used consisted of an extruder (Dr. Collin E20M) with a screw of 20 mm diameter (D) and length of 25×D and T-die head with 25 mm slot width.

Polymer composites with predetermined amount of carbon black and the corresponding films as indicated in the following table 2 were prepared according to the following process: The granules of the masterbatches and corresponding matrix material were dry blended and fed into the hopper. The dry blended materials were then melted and mixed into homogeneous molten in the cylinder of the extruder. The polymer composites in molten state with predetermined amount of carbon black were obtained.

The polymer composites were in situ extruded out from the die. The melt of the polymer composites came out from the die and dropped at the polishing calender. Final shaping and cooling of the material took place on the polishing calender consisting of three rolls. The films made of the polymer composite with a thickness of 100 μm were obtained.

Preparation of Samples of a Two Layer Structure

Samples of a two layer structure of the examples (E1b-E17b) and the comparative example (CE1b) were prepared as following:

Samples of a two layer structure with Layer 1 (Laser sensitive) having a thickness of 100 μm and Layer 2 (substrate) having a thickness of 2,000 μm as indicated in the following table 3 were prepared by an in mould labeling process.

A pre-cut film for Layer 1 was placed into an injection mould having a cavity of 60 mm×60 mm×2 mm. The film stuck to a wall of the cavity electrostatically. The mould was closed and melt of the materbatch was injected to the mould to form Layer 2 and bond the film of Layer 1.

Laser Engraving of the Samples of the Two Layer Structure

Laser engraving was carried out on the samples of E1b-E17b and CE1b on a TruMark 3130 (TRUMPF) machine with the following parameters:

Laser medium: Nd: YVO₄

### Wavelength: 1064 nm

### Power: 10.5 W

### Voltage: 220 V

### DPI: 600

### Frequency: 45000 Hz

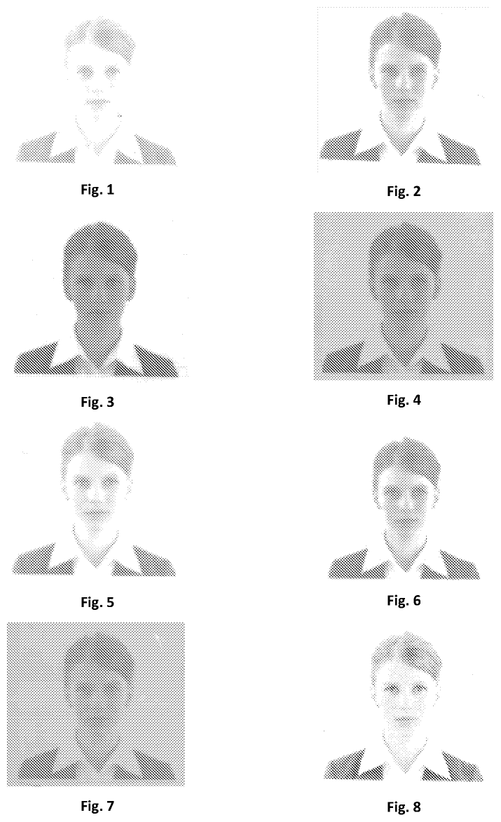

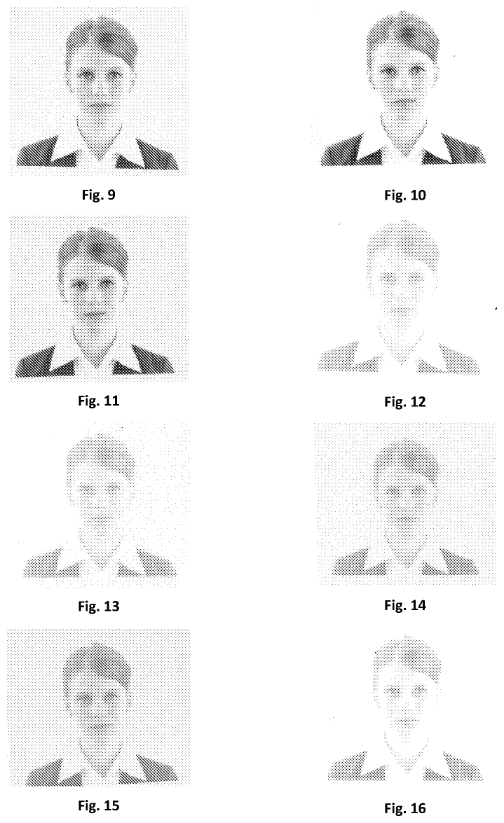

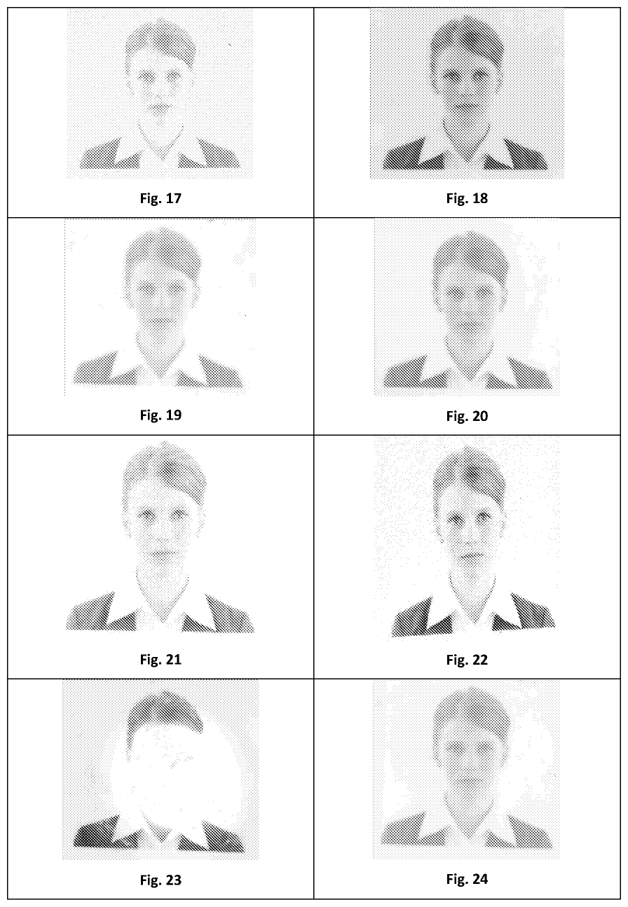

In the laser engraving, a black-and-white portrait of a woman was inscribed in Layer 1 of the individual samples of E1b-E17b and CE1b. As indicated in FIGS. 1-17, an excellent contrast and very good graduation of the greyscales were achieved in E1b-E17b, which is close to or even comparable to the laser engraving performance of CE1b indicated in FIG. 18.

Chemical Resistance Test

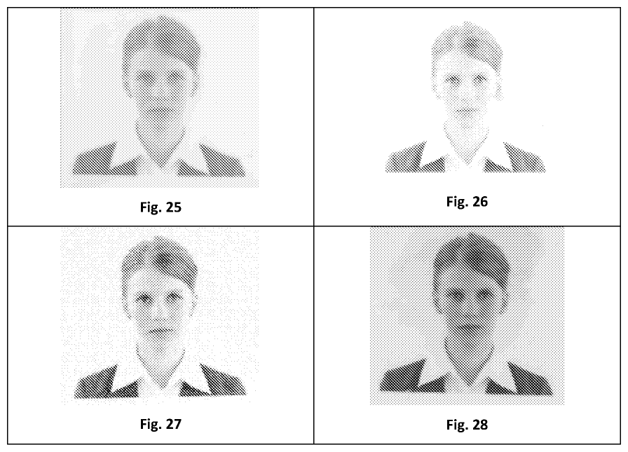

Laser engraved samples of E2b, E6b, E8b, E10b and CE1b were further tested for chemical resistance against an industrial chemical (acetone) and a daily chemical (Banana Boat® Sport Sunscreen Lotion—SPF 30) respectively according to the following procedure. 2 ml of acetone was dropped on a piece of cotton and the cotton was wiped against the facial part of the laser engraved image for 1 min. Damage of the laser engraved image was observed and the result is indicated in FIGS. 19-23. It can been seen that no naked-eye visible damage was observed from the samples made of the polyamides (E2b, E6b, E8b and E10b), while the image disappeared in CE1b, and bubbling, cracking, developed textile and loss of glossy were also observed in CE1b.

2 ml of the Banana Boat® Sport Sunscreen Lotion—SPF 30 was uniformly spread on the facial part of the laser engraved image. The samples were kept in an oven at a temperature of 65° C. and under a humidity of 90% RH for 72 hours. Then the residual lotion was cleaned up. Damage of the laser engraved image was observed and the result is indicated in FIGS. 24-28. It can been seen that no naked-eye visible damage was observed from the samples made of the polyamides (E2b, E6b, E8b and E10b), while there was a discoloration of the image in CE1b, and bubbling, developed textile and loss of glossy were also observed in CE1b.

TABLE 1
Masterbatch

| Recipe | MB1 | MB2 | MB3 | MB4 | MB5 | MB6 | MB7 | MB8 | MB9 |
|---|---|---|---|---|---|---|---|---|---|
| TROGAMID ® | 84.8 | 99.88 | | | | | | | |
| CX7323 (wt %) | | | | | | | | | |
| VESTAMID ® | | | 99.88 | | | | | | |
| L2101F (wt %) | | | | | | | | | |
| TROGAMID ® | | | | 99.88 | | | | | |
| T5000 (wt %) | | | | | | | | | |
| VESTAMID ® | | | | | 99.88 | | | | |
| HTplus M5000 (wt %) | | | | | | | | | |
| VESTAMID ® | | | | | | 99.88 | | | |
| DS22 (wt %) | | | | | | | | | |
| VESTAMID ® | | | | | | | 99.88 | | |
| HS22 (wt %) | | | | | | | | | |
| Panlite ® | | | | | | | | 84.8 | 99.88 |
| L-1250Y (wt %) | | | | | | | | | |
| Ti-Pure ™ | 15 | | | | | | | 15 | |
| R-105 (wt %) | | | | | | | | | |
| Ultranox ® | 0.2 | | | | | | | 0.2 | |
| 626 (wt %) | | | | | | | | | |
| Lampblack | | 0.12 | 0.12 | 0.12 | 0.12 | 0.12 | 0.12 | | 0.12 |
| 101 (wt %) | | | | | | | | | |

TABLE 2
Final polymer composites and the films made thereof

| Recipe | E1a | E2a | E3a | E4a | E5a | E6a | E7a | E8a | E9a | E10a | E11a | E12a | E13a | E14a | E15a | E16a | E17a | CE1a |
|---|---|---|---|---|---|---|---|---|---|---|---|---|---|---|---|---|---|---|
| MB2 (wt %) | 5 | 10 | 15 | 20 | | | | | | | | | | | | | | |
| TROGAMID ® | 95 | 90 | 85 | 80 | | | | | | | | | | | | | | |
| CX7323 (wt %) | | | | | | | | | | | | | | | | | | |
| MB3 (wt %) | | | | | 5 | 10 | 20 | | | | | | | | | | | |
| VESTAMID ® | | | | | 95 | 90 | 80 | | | | | | | | | | | |
| L2101F (wt %) | | | | | | | | | | | | | | | | | | |
| MB4 (wt %) | | | | | | | | 10 | 20 | | | | | | | | | |
| TROGAMID ® | | | | | | | | 90 | 80 | | | | | | | | | |
| T5000 | | | | | | | | | | | | | | | | | | |
| MB5 (wt %) | | | | | | | | | | 10 | 20 | | | | | | | |
| VESTAMID ® | | | | | | | | | | 90 | 80 | | | | | | | |
| HTplus | | | | | | | | | | | | | | | | | | |
| M5000 (wt %) | | | | | | | | | | | | | | | | | | |
| MB6 (wt %) | | | | | | | | | | | | 10 | 12.5 | 15 | 20 | | | |
| VESTAMID ® | | | | | | | | | | | | 90 | 87.5 | 85 | 80 | | | |
| DS22 (wt %) | | | | | | | | | | | | | | | | | | |
| MB7 (wt %) | | | | | | | | | | | | | | | | 10 | 20 | |
| VESTAMID ® | | | | | | | | | | | | | | | | 90 | 80 | |
| HS22 | | | | | | | | | | | | | | | | | | |
| MB9 (wt %) | | | | | | | | | | | | | | | | | | 10 |
| Panlite ® | | | | | | | | | | | | | | | | | | 90 |
| L-1250Y | | | | | | | | | | | | | | | | | | |
| Final | | | | | | | | | | | | | | | | | | |
| composition | E1a | E2a | E3a | E4a | E5a | E6a | E7a | E8a | E9a | E10a | E11a | E12a | E13a | E14a | E15a | E16a | E17a | CE1a |
| Matrix | PA PACM12 | | | | PA12 | | | PA 6-3-T | | PA 6I/6T | | PA1010 | | | | PA610 | | PC |
| Carbon black | 60 | 120 | 180 | 240 | 60 | 120 | 240 | 120 | 240 | 120 | 240 | 120 | 150 | 180 | 240 | 120 | 240 | 120 |
| content | | | | | | | | | | | | | | | | | | |
| (ppm) | | | | | | | | | | | | | | | | | | |

TABLE 3
Samples of a two layer structure

| | E1b | E2b | E3b | E4b | E5b | E6b | E7b | E8b | E9b | E10b | E11b | E12b | E13b | E14b | E15b | E16b | E17b | CE1b |
|---|---|---|---|---|---|---|---|---|---|---|---|---|---|---|---|---|---|---|
| Layer 1 | E1a | E2a | E3a | E4a | E5a | E6a | E7a | E8a | E9a | E10a | E11a | E12a | E13a | E14a | E15a | E16a | E17a | CE1a |

| | | |
|---|---|---|
| Layer 2 | MB1 | MB8 |

Composition of the final samples

| Matrix of | PA PACM12 | | | | PA12 | | | PA 6-3-T | | PA 6I/6T | | PA1010 | | | | PA610 | | PC |
|---|---|---|---|---|---|---|---|---|---|---|---|---|---|---|---|---|---|---|
| Layer 1 | | | | | | | | | | | | | | | | | | |
| Carbon black | 60 | 120 | 180 | 240 | 60 | 120 | 240 | 120 | 240 | 120 | 240 | 120 | 150 | 180 | 240 | 120 | 240 | 120 |
| content in | | | | | | | | | | | | | | | | | | |
| Layer 1 (ppm) | | | | | | | | | | | | | | | | | | |
| Matrix of | PA PACM12 | | | | | | | | | | | | | | | | | PC |
| Layer 2 | | | | | | | | | | | | | | | | | | |
| White | 15% | | | | | | | | | | | | | | | | | |
| pigment | | | | | | | | | | | | | | | | | | |
| content in | | | | | | | | | | | | | | | | | | |
| Layer 2 | | | | | | | | | | | | | | | | | | |

1: A laser markable polymer composite, comprising:
(a) a polyamide component as a matrix, and
(b) carbon black as a laser-sensitive additive,
wherein the polyamide component comprises, based on the total weight thereof, at least 50 wt % a polyamide selected from the group consisting of:
(a1) a linear aliphatic polyamide of the AB type having 10-12 carbon atoms, produced by polymerizing a lactam having from 10-12 carbon atoms in the monomer unit or by polycondensing a ω-aminocarboxylic acid having from 10-12 carbon atoms in the monomer unit,
(a2) a linear aliphatic polyamide of the AABB type, produced by polycondensing a diamine having 6-14 carbon atoms in the monomer unit and a dicarboxylic acid having 9-14 carbon atoms in the monomer unit,
(a3) a cycloaliphatic polyamide, produced by polycondensing a cycloaliphatic diamine having 10-20 carbon atoms in the monomer unit and an aliphatic dicarboxylic acid having 8-18 carbon atoms in the monomer unit, optionally further produced by a lactam having 6-14 carbon atoms or a linear aliphatic ω-aminocarboxylic acid having 6-14 carbon atoms,
(a4) a semi-aromatic polyamide based on a cycloaliphatic diamine having 10-20 carbon atoms and an aromatic dicarboxylic acid having 8-18 carbon atoms, optionally further produced by a lactam having 6-14 carbon atoms or a linear aliphatic ω-aminocarboxylic acid having 6-14 carbon atoms,
(a5) a semi-aromatic polyamide based on an aliphatic diamine having 2-12 carbon atoms and an aromatic dicarboxylic acid having 8-18 carbon atoms, optionally further produced by a lactam having 6-14 carbon atoms or a linear aliphatic oy-aminocarboxylic acid having 6-14 carbon atoms, and
a compound of any two or more of (a1)-(a5) as well as a copolymer thereof, and
wherein the carbon black is present in an amount of 50-300 ppm, based on the total weight of the polymer composite.

2: The laser markable polymer composite of claim 1, wherein the linear aliphatic polyamide (a1) or (a2) is selected from the group consisting of PA88, PA79, PA97, PA610, PA106, PA99, PA810, PA108, PA612, PA126, PA10, PA1010, PA812, PA128, PA614, PA 146, PA11, PA1012, PA1210, PA913, PA139, PA814, PA148, PA616, PA12, PA212, PA113, PA1014, PA1410, PA816, PA618, and a compound or a copolyamide based on these systems.

3: The laser markable polymer composite of claim 1, comprising the cycloaliphatic polyamide (a3), which is based on
a cycloaliphatic diamine selected from the group consisting of bis-(4-amino-3-methyl-cyclohexyl)-methane (MACM), bis-(4-amino-cyclohexyl)-methane (PACM), bis-(4-amino-3-ethyl-cyclohexyl)-methane (EACM), bis-(4-amino-3,5-dimethyl-cyclohexyl)-methane (TMDC), 2,2-(4,4′-diaminodicyclohexyl)propane (PACP), and a mixture thereof, and
an aliphatic dicarboxylic acid selected from the group consisting of sebacic acid, undecanedioic acid, dodecanedioic acid, tridecanedioic acid (brassylic acid), tetradecanedioic acid, pentadecanedioic acid, hexadecanedioic acid, and a mixture thereof.

4: The laser markable polymer composite of claim 1, comprising the semi-aromatic polyamide (a4) which is based on
a cycloaliphatic diamine selected from the group consisting of bis-(4-amino-3-methyl-cyclohexyl)-methane (MACM), bis-(4-amino-cyclohexyl)-methane (PACM), bis-(4-amino-3-ethyl-cyclohexyl)-methane (EACM), bis-(4-amino-3,5-dimethyl-cyclohexyl)-methane (TMDC), 2,2-(4,4′-diaminodicyclohexyl)propane (PACP), and a mixture thereof, and
an aromatic dicarboxylic acid selected from the group consisting of isophthalic acid, terephthalic acid, naphthalene dicarboxylic acid, and a mixture thereof.

5: The laser markable polymer composite of claim 3, wherein the cycloaliphatic polyamide (a3) is selected from the group consisting of MACM10, MACM11, MACM12, MACM13, MACM14, MACM16, PACM10, PACM11, PACM12, PACM13, PACM14, PACM16, TMDC10, TMDC11, TMDC12, TMDC13, TMDC14, TMDC15, TMDC16, and a compound or a copolyamide based on these systems.

6: The laser markable polymer composite of claim 4, wherein the semi-aromatic polyamide (a4) is selected from the group consisting of MACMI/12, MACMT/12, PACMI/12, PACMT/12, and a compound or a copolyamide based on these systems.

7: The laser markable polymer composite of claim 3, wherein the cycloaliphatic diamine is PACM having a content of trans, trans isomer of 30-70%.

8: The laser markable polymer composite of claim 1, wherein the cycloaliphatic polyamide (a3) or the semi-aromatic polyamide (a4) is transparent with a haze of less than 3%, where both properties are determined according to ASTM D1003 on injection moulded test specimens of 2 mm in thickness.

9: The laser markable polymer composite of claim 1, comprising the semi-aromatic polyamide (a5), which is based on
an aliphatic diamine selected from the group consisting of ethylenediamine, butanediamine, pentanediamine, hexamethylenediamine, octanediamine, methyloctanediamine, nonanediamine, decanediamine, undecanediamine, dodecanediamine, trimethylhexamethylenediamine, methylpentanediamine, and a mixture thereof, and
an aromatic dicarboxylic acid selected from the group consisting of isophthalic acid, terephthalic acid, naphthalene dicarboxylic acid, and a mixture thereof.

10: The laser markable polymer composite of claim 9, wherein the semi-aromatic polyamide (a5) is selected from the group consisting of PA6I/6T, PA10T/6T, PA 6T/6I, PA6-3-T, and a compound or a copolyamide based on these systems.

11: The laser markable polymer composite of claim 1, wherein the carbon black
has a particle size of 10 nm-10 μm, and/or
is present in an amount of 100-250 ppm based on the total weight of the polymer composite.

12: The laser markable polymer composite of claim 1, further comprising up to 20 wt % by weight of the composition of one or more additional ingredients, selected from the group consisting of: stabilizers, lubricants, colorants, plasticizers, nucleants, antioxidants, impact modifiers and UV absorbers.

13: The laser markable polymer composite of claim 1, wherein the polyamide component comprises based on the total weight thereof, at least 70 wt % of a polyamide selected from the polyamides (a1), (a2) (a3), (a4), (a5) and the compound thereof as well as the copolymer thereof.

14: A method for producing a moulding, comprising:
moulding the laser markable polymer composite of claim 1 to obtain a moulding which can be marked with the aid of a laser.

15: A moulded article made of the laser markable polymer composite of claim 1.

16: A layered structure, comprising:
(A) at least one layer (A) comprising a thermoplastic plastic, and
(B) at least one layer (B) made of the laser markable polymer composite of claim 1.

17: The layered structure of claim 16, wherein the thermoplastic plastic of layer (A) is selected from the group consisting of cellulose acetate propionate, cellulose acetate butyrate, polyesters, polyamides, polycarbonates, polyimides, polyolefins, polyvinylchlorides, polyvinylacetals, polyethers and polysulphonamides.

18: The layered structure of claim 16, wherein layer (A) comprises a white pigment.

19: The layered structure of claim 16, wherein layer (A) is between two layers (B).

20: The layered structure of claim 16, wherein between layer (A) and the layer(s) (B) the layered structure has at least one further layer comprising at least one thermoplastic plastic.

21: A process for the production of the layered structure of claim 16, the process comprising:
bonding various films of plastic to one another by a process selected from the group consisting of lamination, coextrusion, in mould labeling, and direct gluing.

22: A security and/or valuable document, comprising:
the layered structure of claim 16.
